(19) United States
(12) Patent Application Publication
(10) Pub. No.: US 2023/0239581 A1
(43) Pub. Date: Jul. 27, 2023

(54) ELECTRICAL DEVICE, METHOD OF GENERATING IMAGE DATA, AND NON-TRANSITORY COMPUTER READABLE MEDIUM

(71) Applicant: GUANGDONG OPPO MOBILE TELECOMMUNICATIONS CORP., LTD., Dongguan (CN)

(72) Inventor: Toshihiko Arai, Yokohama (JP)

(21) Appl. No.: 18/131,110

(22) Filed: Apr. 5, 2023

Related U.S. Application Data
(63) Continuation of application No. PCT/CN2020/127172, filed on Nov. 6, 2020.

(51) Int. Cl. H04N 23/84; H04N 25/46

(52) U.S. Cl. CPC H04N 23/84; H04N 25/46

(57) ABSTRACT

An electrical device includes: a camera assembly that includes an image sensor configured to capture an image of an object and to generate color image data, wherein the image sensor has the green element blocks, the blue element blocks, and the red element blocks arranged in an array of the Bayer format at each pixel position in order to generate color image data, the green element blocks, the blue element blocks, and the red element blocks includes Multiple physical pixel elements respectively, the green element block includes two green physical pixel elements and two white physical pixel elements, the blue element block includes two blue physical pixel elements and two white physical pixel elements, and the red element block includes two red physical pixel elements and two white physical pixel elements; and a main processor that performs image process.

### CROSS-REFERENCE TO RELATED APPLICATION

This application is a continuation of International Application No. PCT/CN2020/127172, filed on Nov. 06, 2020, the entire disclosures of which are incorporated herein by reference.

### TECHNICAL FIELD

The present disclosure relates to a method of generating an image data, an electrical device implementing such method and a non-transitory computer readable medium including program instructions stored thereon for performing such method.

### BACKGROUND

Electrical devices such as smartphones and tablet terminals are widely used in our daily life. Nowadays, many of the electrical devices are equipped with a camera assembly to capture an image. Some of the electrical devices are portable and are thus easy to carry. Therefore, a user of the electrical device can easily take a picture of an object by using the camera assembly of the electrical device anytime, anywhere.

There are many formats to capture the image of the object and generate the target image data thereof. One of the widely known formats is a Bayer format which includes a sparse image data.

In addition to the sparse image data, in order to improve a quality of the image of the object based on the target image data, a dense image data is also generated when the camera assembly captures the object.

Here, FIG. 8 is a diagram showing an example of a conventional technique for acquiring BGB image data and white image data using the RGB camera and the mono camera.

As shown in FIG. 8, in the prior art, the outputs of the special format sensors require the special process. For good resolution image, the RGB censor of the RGB camera and the W sensor of the mono camera are proposed, the RGB and W sensors output the RGB (Bayer) image and White image. Therefore, the system of the prior art requires more data transfer resource and special treatment (for example, including the position fitting) for the white image.

On the other hand, FIG. 9 is a diagram showing an example of a conventional technique for acquiring BGB image data and white image data using a pixel array conforming to the Bayer Format.

As shown in FIG. 9, in the prior art, the image sensor includes clear filter (w: white) pixel onto typical RGB sparse (Bayer RAW) image sensor. In that case, the RGB Bayer image and White image are obtained.

However, the system of the prior art requires more data transfer resource and special treatment for the white image.

### SUMMARY

The present disclosure aims to solve at least one of the technical problems mentioned above. Accordingly, the present disclosure needs to provide a method of generating an image data and an electrical device implementing such method.

In accordance with the present disclosure, an electrical device, may include:
a camera assembly that includes an image sensor configured to capture an image of an object and to generate color image data, wherein the image sensor has the green element blocks, the blue element blocks, and the red element blocks arranged in an array of the Bayer format at each pixel position in order to generate color image data, the green element blocks, the blue element blocks, and the red element blocks includes Multiple physical pixel elements respectively, the green element block includes two green physical pixel elements and two white physical pixel elements, the blue element block includes two blue physical pixel elements and two white physical pixel elements, and the red element block includes two red physical pixel elements and two white physical pixel elements; and
a main processor that performs image process, wherein
the camera assembly acquires the green binning image data and the white binning image data of the green element block, the red binning image data and the white binning image data of the red element block, and the blue binning image data and the white binning image data of the blue element block, generated by the binning process of the camera assembly,
the camera assembly calculates a green-white ratio of the green binning image data and the white binning image data of the green element block,
the camera assembly acquires white residual data based on a difference between the white binning image data of the red element block or the blue element block, at a first pixel position where estimate green residual data should be estimated, and the white binning image data of the green element block, at the second pixel position adjacent to the first pixel position, and
the camera assembly estimates estimate green residual data corresponding to the first pixel position, based on the green-white ratio corresponding to the green element block at the second pixel position and the white residual data.

In some embodiments, wherein the camera assembly acquires the white residual data, by subtracting the white binning image data of the green element block located at the second pixel position from the white binning image data of the red element block or the blue element block at the first pixel position.

In some embodiments, wherein the camera assembly acquires the estimate green residual data, by multiplying the green-white ratio corresponding to the green element block located at the second pixel position with the white residual data.

In some embodiments, wherein the green element blocks, the blue element blocks, and the red element blocks have rectangular shape, and wherein
in the green element block, the two green physical pixel elements are located on a first diagonal line, and the two white physical pixel elements are located on a second diagonal line, corresponding to each of four corners, respectively,
in the blue element block, the two blue physical pixel elements are located on a first diagonal line, and the two white physical pixel elements are located on a second diagonal line, corresponding to each of four corners, respectively, and
in the red element block, the two red physical pixel elements are located on a first diagonal line, and the two white physical pixel elements are located on a second diagonal line, corresponding to each of four corners, respectively.

In some embodiments, wherein the camera assembly generates the green binning image data and the white binning image data of the green element block, the red binning image data and the white binning image data of the red element block, and the blue binning image data and white binning image data of the blue element block, by a binning process by using the image sensor.

In some embodiments, wherein the camera assembly uses the green binning image data of the green element block, the red binning image data of the red element block, and the blue binning image data of the blue element block as the sparse image data conforming to the Bayer format.

In some embodiments, wherein the camera assembly generates the embedded sparse image data from the sparse image data, by embedding the estimate green residual data in the sparse image data at the first pixel position.

In some embodiments, the electrical device further comprises
an image signal processor which processes the sparse image data in the embedded sparse image data to generate a target image data,
wherein the camera assembly inputs the embedded sparse image data to the image signal processor.

In some embodiments, wherein
the main processor obtains the embedded sparse image data from the image signal processor after the embedded sparse image data has been input to the image signal processor,
the main processor extracts the estimate green residual data from the embedded sparse image data obtained from the image signal processor, and
the main processor reconstructs the dense image data based on the estimate green residual data.

In accordance with the present disclosure, a method of generating an image data, may include:
acquiring green binning image data and white binning image data of green element blocks, red binning image data and white binning image data of red element blocks, and blue binning image data and white binning image data of blue element block, generated by the binning process of a camera assembly, wherein the camera assembly that includes an image sensor configured to capture an image of an object and to generate color image data, wherein the image sensor has the green element blocks, the blue element blocks, and the red element blocks arranged in an array of the Bayer format at each pixel position in order to generate color image data, the green element blocks, the blue element blocks, and the red element blocks includes Multiple physical pixel elements respectively, the green element block includes two green physical pixel elements and two white physical pixel elements, the blue element block includes two blue physical pixel elements and two white physical pixel elements, and the red element block includes two red physical pixel elements and two white physical pixel elements;
calculating a green-white ratio of the green binning image data and the white binning image data of the green element block;
acquiring white residual data based on a difference between the white binning image data of the red element block or the blue element block, at a first pixel position where estimate green residual data should be estimated, and the white binning image data of the green element block, at the second pixel position adjacent to the first pixel position; and
estimating estimate green residual data corresponding to the first pixel position, based on the green-white ratio corresponding to the green element block at the second pixel position and the white residual data.

In accordance with the present disclosure, a non-transitory computer readable medium may include program instructions stored thereon for performing at least the following:
acquiring green binning image data and white binning image data of green element blocks, red binning image data and white binning image data of red element blocks, and blue binning image data and white binning image data of blue element block, generated by the binning process of a camera assembly, wherein the camera assembly that includes an image sensor configured to capture an image of an object and to generate color image data, wherein the image sensor has the green element blocks, the blue element blocks, and the red element blocks arranged in an array of the Bayer format at each pixel position in order to generate color image data, the green element blocks, the blue element blocks, and the red element blocks includes Multiple physical pixel elements respectively, the green element block includes two green physical pixel elements and two white physical pixel elements, the blue element block includes two blue physical pixel elements and two white physical pixel elements, and the red element block includes two red physical pixel elements and two white physical pixel elements;
calculating a green-white ratio of the green binning image data and the white binning image data of the green element block;
acquiring white residual data based on a difference between the white binning image data of the red element block or the blue element block, at a first pixel position where estimate green residual data should be estimated, and the white binning image data of the green element block, at the second pixel position adjacent to the first pixel position; and
estimating estimate green residual data corresponding to the first pixel position, based on the green-white ratio corresponding to the green element block at the second pixel position and the white residual data.

### BRIEF DESCRIPTION OF THE DRAWINGS

These and/or other aspects and advantages of embodiments of the present disclosure will become apparent and more readily appreciated from the following descriptions made with reference to the drawings, in which:

FIG. 1 illustrates a plan view of a first side of an electrical device according to an embodiment of the present disclosure;

FIG. 2 illustrates a plan view of a second side of the electrical device according to the embodiment of the present disclosure;

FIG. 3 illustrates a block diagram of the electrical device according to the embodiment of the present disclosure;

FIG. 4 illustrates a part of a pixel array of the image sensor of the camera assembly according to the embodiment of the present disclosure;

FIG. 5A is a diagram showing an example of a process for generating image data conforming to the Bayer format according to the embodiment of the present disclosure;

FIG. 5B is a diagram showing an example of processing for generating target image data according to the embodiment of the present disclosure, following FIG. 5A;

FIG. 6 is a diagram showing an example of a flow for generating embedded sparse image data for the camera assembly to input to the image signal processor in the image data processing shown in FIG. 5A;

FIG. 7A is a diagram for explaining the calculation of the white residual data of the white image data of the adjacent green pixel block and the red pixel block shown in FIG. 5A;

FIG. 7B is a diagram for explaining the arrangement of the green residual data estimated based on the white residual data of the white image data;

FIG. 8 is a diagram showing an example of a conventional technique for acquiring BGB image data and white image data using the RGB camera and the mono camera; and

FIG. 9 is a diagram showing an example of a conventional technique for acquiring BGB image data and white image data using a pixel array conforming to Bayer Format.

### DETAILED DESCRIPTION

Embodiments of the present disclosure will be described in detail and examples of the embodiments will be illustrated in the accompanying drawings. The same or similar elements and the elements having same or similar functions are denoted by like reference numerals throughout the descriptions. The embodiments described herein with reference to the drawings are explanatory, which aim to illustrate the present disclosure, but shall not be construed to limit the present disclosure.

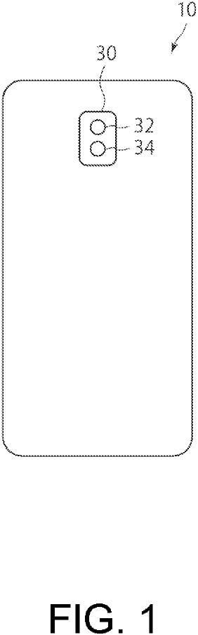

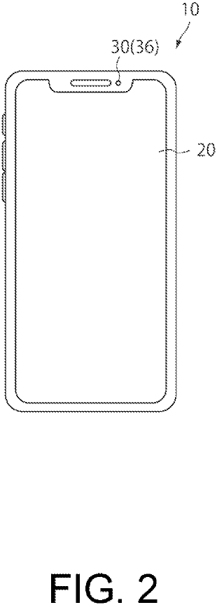

FIG. 1 illustrates a plan view of a first side of an electrical device 10 according to an embodiment of the present disclosure and FIG. 2 illustrates a plan view of a second side of the electrical device 10 according to the embodiment of the present disclosure. The first side may be referred to as a back side of the electrical device 10 whereas the second side may be referred to as a front side of the electrical device 10.

As shown in FIG. 1 and FIG. 2, the electrical device 10 may include a display 20 and a camera assembly 30. In the present embodiment, the camera assembly 30 includes a first main camera 32, a second main camera 34 and a sub camera 36. The first main camera 32 and the second main camera 34 can capture an image in a first side of the electrical device 10 and the sub camera 36 can capture an image in the second side of the electrical device 10. Therefore, the first main camera 32 and the second main camera 34 are so-called out-cameras whereas the sub camera 36 is a so-called in-camera. As an example, the electrical device 10 can be a mobile phone, a tablet computer, a personal digital assistant, and so on.

Although the electrical device 10 according to the present embodiment has three cameras, the electrical device 10 may have less than three cameras or more than three cameras. For example, the electrical device 10 may have two, four, five, and so on, cameras.

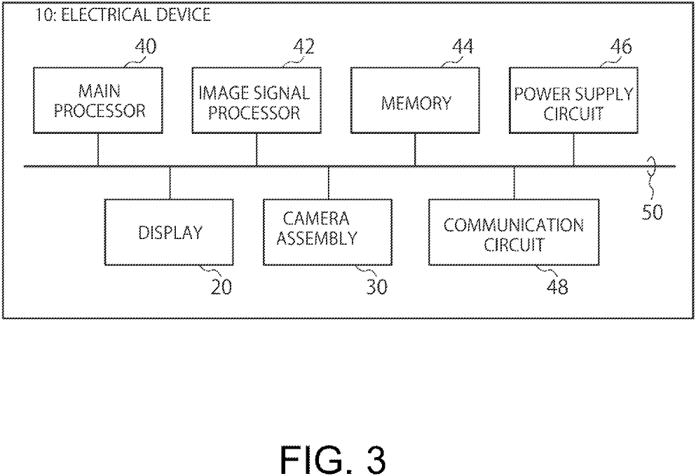

FIG. 3 illustrates a block diagram of the electrical device 10 according to the present embodiment. As shown in FIG. 3, in addition to the display 20 and the camera assembly 30, the electrical device 10 may include a main processor 40, an image signal processor 42, a memory 44, a power supply circuit 46 and a communication circuit 48. The display 20, the camera assembly 30, the main processor 40, the image signal processor 42, the memory 44, the power supply circuit 46 and the communication circuit 48 are connected each other via a bus 50.

The main processor 40 executes one or more programs stored in the memory 44. The main processor 40 implements various applications and data processing (including image data processing) of the electrical device 10 by executing the programs. The main processor 40 may be one or more computer processors. The main processor 40 is not limited to one CPU core, but it may have a plurality of CPU cores. The main processor 40 may be a main CPU of the electrical device 10, an image processing unit (IPU) or a DSP provided with the camera assembly 30.

The image signal processor 42 controls the camera assembly 30 and processes various kinds of image data captured by the camera assembly 30 to generate a target image data. For example, the image signal processor 42 can execute a de-mosaic process, a noise reduction process, an auto exposure process, an auto focus process, an auto white balance process, a high dynamic range process and so on, to the image data captured by the camera assembly 30.

In the present embodiment, the main processor 40 and the image signal processor 42 collaborate with each other to generate a target image data of the object captured by the camera assembly 30. That is, the main processor 40 and the image signal processor 42 are configured to capture the image of the object by the camera assembly 30 and execute various kinds of image processes to the captured image data.

The memory 44 stores a program to be executed by the main processor 40 and the image signal processor 42, and various kinds of data. For example, data of the captured image are stored in the memory 44.

The memory 44 may include a high-speed RAM memory, and/or a non-volatile memory such as a flash memory and a magnetic disk memory. That is, the memory 44 may include a non-transitory computer readable medium, in which the program is stored.

The power supply circuit 46 may have a battery such as a lithium-ion rechargeable battery and a battery management unit (BMU) for managing the battery.

The communication circuit 48 is configured to receive and transmit data to communicate with base stations of the telecommunication network system, the Internet or other devices via wireless communication. The wireless communication may adopt any communication standard or protocol, including but not limited to GSM (Global System for Mobile communication), CDMA (Code Division Multiple Access), LTE (Long Term Evolution), LTE-Advanced, 5th generation (5G). The communication circuit 48 may include an antenna and a RF (radio frequency) circuit.

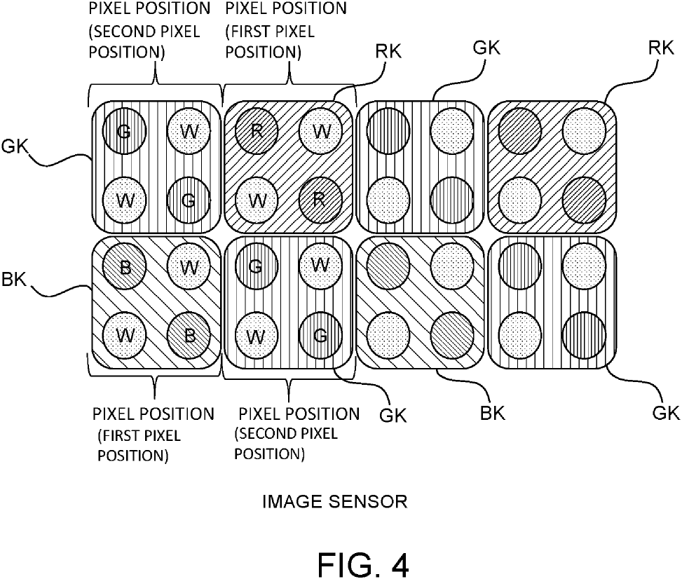

Here, FIG. 4 illustrates a part of a pixel array of the image sensor of the camera assembly 30 according to the embodiment of the present disclosure. In FIG. 4, for example, the eight pixel positions are illustrated.

As shown in FIG. 4, the camera assembly 30 includes an image sensor that captures an image of an object and generates color image data.

Then, for example, as shown in FIG. 4, the image sensor has the green element blocks GK, the blue element blocks BK, and the red element blocks RK arranged in an array of the Bayer format at each pixel position in order to generate color image data. In the Bayer format, the number of green pixels is twice as many as the number of red pixels or the number of blue pixels in the sparse image data. The green element blocks GK, the blue element blocks BK, and the red element blocks RK contain Multiple physical pixel elements (the four physical pixel elements in the example of FIG. 4), respectively. The green element blocks GK, the blue element blocks BK, and the red element blocks RK have a rectangular shape. That is, as shown in FIG. 4, the pixel array of the present embodiment employs 2X2 binning technology.

As shown in FIG. 4, the green element block GK includes two green physical pixel elements G and two white physical pixel elements W. In the green element block GK, the two green physical pixel elements G are located on the first diagonal line, and the two white physical pixel elements W are located on the second diagonal line, corresponding to each of the four corners, respectively.

For example, the signal value (the green binning image data) of the green is generated by combing two electric charges in the two green physical pixel elements G. Furthermore, the signal value (the white binning image data) of the white is generated by combing two electric charges in the two white physical pixel elements W.

Furthermore, in this embodiment, as shown in FIG. 4, the blue element block BK includes two blue physical pixel elements B and two white physical pixel elements W. In the blue element block BK, the two blue physical pixel elements B are located on the first diagonal line, and the two white physical pixel elements W are located on the second diagonal line, corresponding to each of the four corners, respectively.

For example, the signal value (the blue binning image data) of the blue is generated by combing two electric charges in the two blue physical pixel elements B. Furthermore, the signal value (the white binning image data) of the white is generated by combing two electric charges in the two white physical pixel elements W.

Furthermore, in this embodiment, as shown in FIG. 4, the red element block RK includes two red physical pixel elements R and two white physical pixel elements W. In the red element block RK, the two red physical pixel elements R are located on the first diagonal line, and the two white physical pixel elements W are located on the second diagonal line, corresponding to each of the four corners, respectively.

For example, the signal value (the red binning image data) of the red is generated by combing two electric charges in the two red physical pixel elements R. Furthermore, the signal value (the white binning image data) of the white is generated by combing two electric charges in the two white physical pixel elements W.

Next, an example of the operation including the image processing in which the electrical device 10 having the above configuration acquires the image data conforming to the Bayer format will be described, as follow.

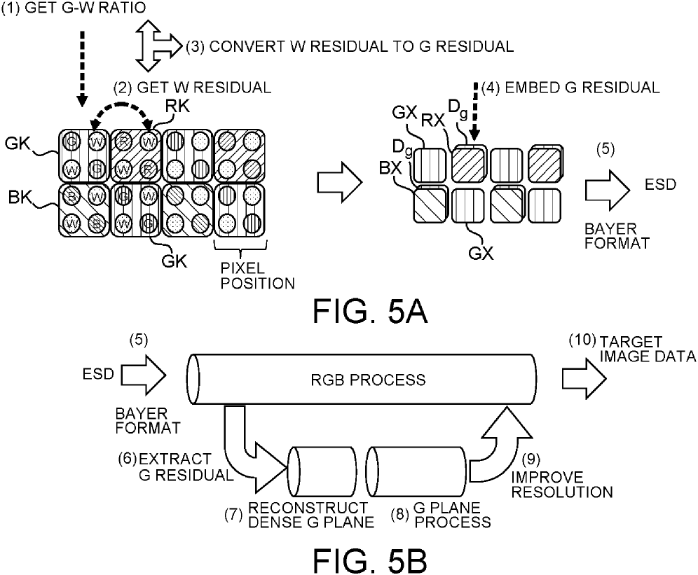

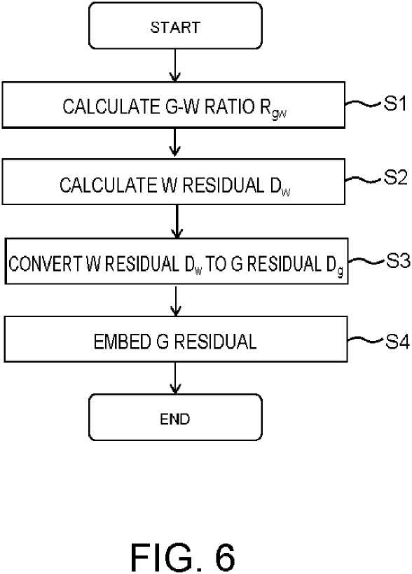

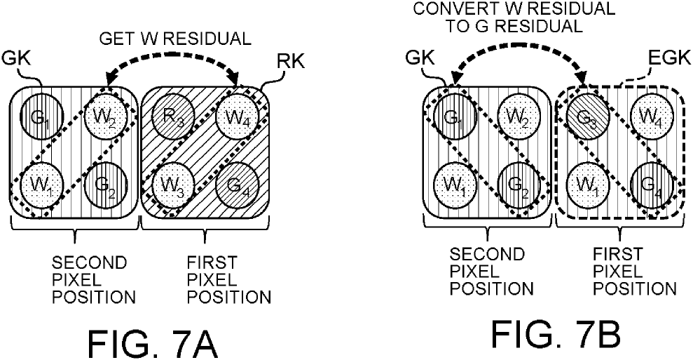

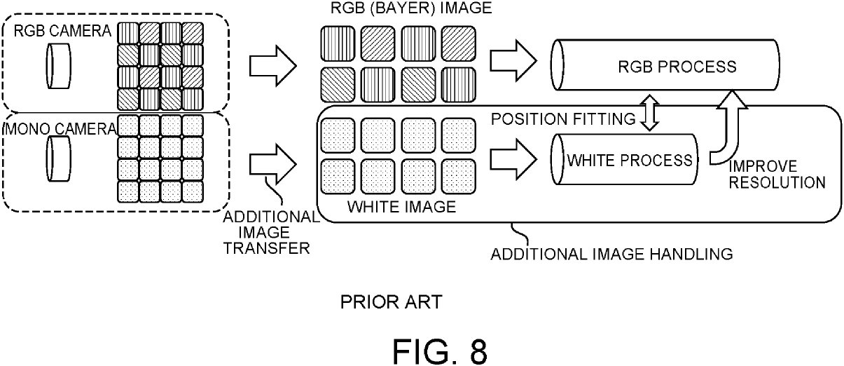

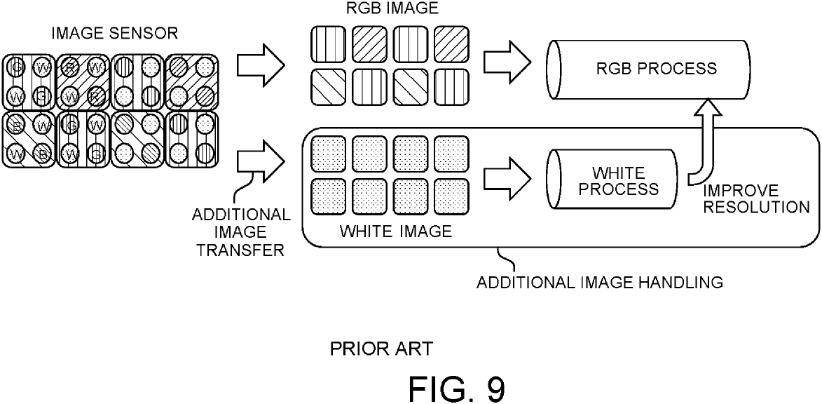

Here, FIG. 5A is a diagram showing an example of a process for generating image data conforming to the Bayer format according to the embodiment of the present disclosure. FIG. 5B is a diagram showing an example of processing for generating target image data according to the embodiment of the present disclosure, following FIG. 5A. FIG. 6 is a diagram showing an example of a flow for generating embedded sparse image data for the camera assembly to input to the image signal processor in the image data processing shown in FIG. 5A. FIG. 7A is a diagram for explaining the calculation of the white residual data of the white image data of the adjacent green pixel block and the red pixel block shown in FIG. 5A. FIG. 7B is a diagram for explaining the arrangement of the green residual data estimated based on the white residual data of the white image data. Note that FIG. 7A and FIG. 7B show an example in which the red element block RK is located at the first pixel position, but the same applies when the blue element block BK is located at the first pixel position.

In the present embodiment, the target image generation process is executed by, for example, the main processor 40 in order to generate the target image data. However, the main processor 40 collaborates with the image signal processor 42 to generate the target image data. Therefore, the main processor 40 and the image signal processor 42 constitute an image processor in the present embodiment.

In addition, in the present embodiment, program instructions of the target image generation process are stored in the non-transitory computer readable medium of the memory 44. When the program instructions are read out from the memory 44 and executed in the main processor 40, the main processor 40 implements the target image generation process illustrated in FIGS. 5A, 5B and FIG. 6.

First, as shown in FIG. 5A, the camera assembly 30 generates the green binning image data and the white binning image data of the green element block GK, the red binning image data and the white binning image data of the red element block RK, and the blue binning image data and white binning image data of the blue element block BK, by a binning process by using the image sensor.

More specifically, the camera assembly 30 generates the green binning image data obtained by combining the charges of the two green physical pixel elements of the green element block GK and the white binning image data obtained by combining the charges of the two white physical pixel elements of the green element block GK, by the binning process.

Similarly, the camera assembly 30 generates the blue binning image data obtained by combining the charges of the two blue physical pixel elements of the blue element block BK and the white binning image data obtained by combining the charges of the two white physical pixel elements of the blue element block BK, by the binning process.

Similarly, the camera assembly 30 generates the red binning image data obtained by combining the charges of the two red physical pixel elements of the red element block RK and the white binning image data obtained by combining the charges of the two white physical pixel elements of the red element block RK, by the binning process.

Next, The camera assembly 30 acquires the green binning image data and the white binning image data of the green element block GK, the red binning image data and the white binning image data of the red element block RK, and the blue binning image data and the white binning image data of the blue element block BK, generated by the binning process of the camera assembly 30.

Then, as shown in FIG. 5A, the camera assembly 30 uses the green binning image data of the green element block GK, the red binning image data of the red element block RK, and the blue binning image data of the blue element block BK as the sparse image data RX, GX, and BX conforming to the Bayer format.

Next, as shown in step S1 of FIG. 6, the camera assembly 30 calculates the green-white ratio R_{gw} of the green binning image data and the white binning image data of the green element block GK ((1) in FIG. 5A).

For example, in the case of focusing on the two pixel positions shown in FIG. 7A, as shown in the following formula, the camera assembly 30 calculates the green-white ratio Rgw of the green binning image data (G₁ + G₂) and the white binning image data (W₁ + W₂) of the green element block GK.

$${R}_{g w} \text{=} \left({G}_{1} \text{+} {G}_{2}\right) / \left({W}_{1} \text{+} {W}_{2}\right)$$

Next, as shown in step S2 of FIG. 6, the camera assembly 30 acquires the white residual data D_{w} based on the difference between the white binning image data of the red element block RK (or the blue element block BK) at the first pixel position where the estimate green residual data Dg should be estimated and the white binning image data of the green element block GK at the second pixel position adjacent to the first pixel position ((2) in FIG. 5A).

For more details, the camera assembly 30 acquires the white residual data D_{w}, by subtracting the white binning image data of the green element block GK located at the second pixel position from the white binning image data of the red element block RK (or the blue element block BK) at the first pixel position.

For example, in the case of focusing on the two pixel positions shown in FIG. 7A, as shown in the following formula, the camera assembly 30 acquires the white residual data D_{w}, by subtracting the white binning image data (W₁ + W₂) of the green element block GK located at the second pixel position from the white binning image data (W₃ + W₄) of the red element block RK at the first pixel position.

$${D}_{w} = \left({W}_{3} \text{+} {W}_{4}\right) - \left({W}_{1} \text{+} {W}_{2}\right)$$

Next, as shown in step S3 of FIG. 6, the camera assembly 30 estimates the estimate green residual data Dg corresponding to the first pixel position, based on the green-white ratio R_{gw} corresponding to the green element block GK at the second pixel position and the white residual data D_{w} ((3) in FIG. 5A).

For more details, as shown in the formula below, the camera assembly 30 acquires the estimate green residual data D_{g}, by multiplying the green-white ratio R_{gw} corresponding to the green element block GK located at the second pixel position with the white residual data.

$${D}_{g} \text{} = \text{} {D}_{w} \text{} \times \text{} {R}_{g w}$$

Then, as shown in step S4 of FIG. 6, the camera assembly 30 generates the embedded sparse image data ESD from the sparse image data, by embedding the estimate green residual data D_{g} (or data based on the estimate green residual data D_{g}) in the sparse image data RX and BX at the first pixel position ((4) in FIG. 5A).

For example, in the case of focusing on the two pixel positions shown in FIG. 7A, it is assumed that the green element block EGK for the dense image data is located at the first pixel position (FIG. 7B). In this case, as shown in the formula below, the estimate green residual data D_{g} is the difference between the estimate green binning image data (G₃ + G₄) of the assumed green element block EGK and the green binning image data (G₁ + G₂) of the green element block GK.

$${D}_{g} \text{} = \text{} E s t i m a t e d \left(\left({G}_{3} \text{} + \text{} {G}_{4}\right) \text{} \text{-} \text{} \left({G}_{1} \text{} + \text{} {G}_{2}\right)\right)$$

Next, as shown in FIG. 5B, the camera assembly 30 inputs the embedded sparse image data ESD to the image signal processor 42 ((5) in FIG. 5B). The image signal processor 42 processes the sparse image data in the embedded sparse image data to generate the target image data (RGB Process).

Then, as shown in FIG. 5B, the main processor 40 obtains the embedded sparse image data ESD from the image signal processor 42 after the embedded sparse image data has been input to the image signal processor. That is, the image signal processor 42 has one or more data output ports to output various kinds of data during processing and one or more data input ports to input various kinds of data to the image signal processor 42. Therefore, the main processor 40 obtains the embedded sparse image data via one of the data output ports of the image signal processor 42.

Then, as shown in FIG. 5B, the main processor 40 extracts the estimate green residual data D_{g} from the embedded sparse image data obtained from the image signal processor ((6) in FIG. 5B).

Then, as shown in FIG. 5B, the main processor 40 reconstructs the dense image data based on the estimate green residual data D_{g} ((7) in FIG. 5B).

Then, the main processor 40 executes the predetermined plane process on the dense image data ((8) in FIG. 5B).

If necessary, for example, the main processor 40 may generate a compressed data based on the estimate green residual data D_{g}. There are various ways to compress the residual data to reduce the number of bits of the residual data.

In this case, if necessary, the main processor 40 may generate the embedded sparse image data, by embedding the compressed data obtained by compressing the estimate green residual data D_{g} in the sparse image data corresponding to the first pixel position ((4) in FIG. 5A). Furthermore, in this case, the main processor expands the compressed data generated from the split data the embedded sparse image data from the image signal processor. Then, the main processor reconstructing the dense image data based on the residual data reconstructed from the compressed data ((6) in FIG. 5B).

Furthermore, for example, the main processor 40 obtains a generated image data based on the sparse image data from one of the data output ports of the image signal processor 42. The generated image data during processing based on the sparse image data can be obtained from the image signal processor 42.

Next, for example, the main processor 40 combines the dense image data reconstructed and the generated image data to generate a combined image data.

Next, for example, the main processor 40 inputs the combined image data to one of the data input ports of the image signal processor 42 to improve the resolution ((9) of FIG. 5B). Thereafter, the image signal processor 42 continues processing for the combined image data, and the target image data is eventually output from the image signal processor 42 ((10) in FIG. 5B).

For example, an image to be displayed on the display 20 may be generated based on the target image data. Alternatively, the target image data may be stored in the memory 44. There are a variety of formats for the target image data. For instance, the formats of the target image data are JPEG, TIFF, GIF or the like.

As described above, in accordance with the electrical device 10 according to the present embodiment, the dense image data can be embedded as the residual data into the sparse image data which is input to the image signal processor 42, and then the dense image can be reconstructed based on the residual data embedded in the sparse image data. As a result, the image based on the dense image data can be regenerated and the quality of the target image data can be improved by combining the generated image data based on the sparse image data and the dense image data reconstructed from the residual data in the embedded sparse image data.

In addition, since the format of the embedded sparse image data is the same as the format of the sparse image data, a common image signal processor for the sparse image data can still be used as the image signal processor 42 for the embedded sparse image data. Therefore, it is not necessary to newly develop the image signal processor 42 to process the embedded sparse image data of the present embodiment to generate the target image data.

In the description of embodiments of the present disclosure, it is to be understood that terms such as “central”, “longitudinal”, “transverse”, “length”, “width”, “thickness”, “upper”, “lower”, “front”, “rear”, “back”, “left”, “right”, “vertical”, “horizontal”, “top”, “bottom”, “inner”, “outer”, “clockwise” and “counterclockwise” should be construed to refer to the orientation or the position as described or as shown in the drawings under discussion. These relative terms are only used to simplify description of the present disclosure, and do not indicate or imply that the device or element referred to must have a particular orientation, or constructed or operated in a particular orientation. Thus, these terms cannot be constructed to limit the present disclosure.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present disclosure, “a plurality of” means two or more than two, unless specified otherwise.

In the description of embodiments of the present disclosure, unless specified or limited otherwise, the terms “mounted”, “connected”, “coupled” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the embodiments of the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Various embodiments and examples are provided in the above description to implement different structures of the present disclosure. In order to simplify the present disclosure, certain elements and settings are described in the above. However, these elements and settings are only by way of example and are not intended to limit the present disclosure. In addition, reference numbers and/or reference letters may be repeated in different examples in the present disclosure. This repetition is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

Reference throughout this specification to “an embodiment”, “some embodiments”, “an exemplary embodiment”, “an example”, “a specific example” or “some examples” means that a particular feature, structure, material, or characteristics described in connection with the embodiment or example is included in at least one embodiment or example of the present disclosure. Thus, the appearances of the above phrases throughout this specification are not necessarily referring to the same embodiment or example of the present disclosure. Furthermore, the particular features, structures, materials, or characteristics may be combined in any suitable manner in one or more embodiments or examples.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which it should be understood by those skilled in the art that functions may be implemented in a sequence other than the sequences shown or discussed, including in a substantially identical sequence or in an opposite sequence.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although embodiments of the present disclosure have been shown and described, it would be appreciated by those skilled in the art that the embodiments are explanatory and cannot be construed to limit the present disclosure, and changes, modifications, alternatives and variations can be made in the embodiments without departing from the scope of the present disclosure.

What is claimed:

1. An electrical device, comprising:
a camera assembly that includes an image sensor configured to capture an image of an object and to generate color image data, wherein the image sensor has the green element blocks, the blue element blocks, and the red element blocks arranged in an array of the Bayer format at each pixel position in order to generate color image data, the green element blocks, the blue element blocks, and the red element blocks includes Multiple physical pixel elements respectively, the green element block includes two green physical pixel elements and two white physical pixel elements, the blue element block includes two blue physical pixel elements and two white physical pixel elements, and the red element block includes two red physical pixel elements and two white physical pixel elements; and
a main processor that performs image process, wherein
the camera assembly acquires the green binning image data and the white binning image data of the green element block, the red binning image data and the white binning image data of the red element block, and the blue binning image data and the white binning image data of the blue element block, generated by the binning process of the camera assembly,
the camera assembly calculates a green-white ratio of the green binning image data and the white binning image data of the green element block,
the camera assembly acquires white residual data based on a difference between the white binning image data of the red element block or the blue element block, at a first pixel position where estimate green residual data should be estimated, and the white binning image data of the green element block, at the second pixel position adjacent to the first pixel position, and
the camera assembly estimates estimate green residual data corresponding to the first pixel position, based on the green-white ratio corresponding to the green element block at the second pixel position and the white residual data.

2. The electrical device according to claim 1,
wherein the camera assembly acquires the white residual data, by subtracting the white binning image data of the green element block located at the second pixel position from the white binning image data of the red element block or the blue element block at the first pixel position.

3. The electrical device according to claim 1,
wherein the camera assembly acquires the estimate green residual data, by multiplying the green-white ratio corresponding to the green element block located at the second pixel position with the white residual data.

4. The electrical device according to claim 1, wherein the green element blocks, the blue element blocks, and the red element blocks have rectangular shape, and wherein
in the green element block, the two green physical pixel elements are located on a first diagonal line, and the two white physical pixel elements are located on a second diagonal line, corresponding to each of four corners, respectively,
in the blue element block, the two blue physical pixel elements are located on a first diagonal line, and the two white physical pixel elements are located on a second diagonal line, corresponding to each of four corners, respectively, and
in the red element block, the two red physical pixel elements are located on a first diagonal line, and the two white physical pixel elements are located on a second diagonal line, corresponding to each of four corners, respectively.

5. The electrical device according to claim 1,
wherein the camera assembly generates the green binning image data and the white binning image data of the green element block, the red binning image data and the white binning image data of the red element block, and the blue binning image data and white binning image data of the blue element block, by a binning process by using the image sensor.

6. The electrical device according to claim 1,
wherein the camera assembly uses the green binning image data of the green element block, the red binning image data of the red element block, and the blue binning image data of the blue element block as the sparse image data conforming to the Bayer format.

7. The electrical device according to claim 6,
wherein the camera assembly generates the embedded sparse image data from the sparse image data, by embedding the estimate green residual data in the sparse image data at the first pixel position.

8. The electrical device according to claim 7, further comprising
an image signal processor which processes the sparse image data in the embedded sparse image data to generate a target image data,
wherein the camera assembly inputs the embedded sparse image data to the image signal processor.

9. The electrical device according to claim 8, wherein
the main processor obtains the embedded sparse image data from the image signal processor after the embedded sparse image data has been input to the image signal processor,
the main processor extracts the estimate green residual data from the embedded sparse image data obtained from the image signal processor, and
the main processor reconstructs the dense image data based on the estimate green residual data.

10. A method of generating an image data, comprising:
acquiring green binning image data and white binning image data of green element blocks, red binning image data and white binning image data of red element blocks, and blue binning image data and white binning image data of blue element block, generated by the binning process of a camera assembly, wherein the camera assembly that includes an image sensor configured to capture an image of an object and to generate color image data, wherein the image sensor has the green element blocks, the blue element blocks, and the red element blocks arranged in an array of the Bayer format at each pixel position in order to generate color image data, the green element blocks, the blue element blocks, and the red element blocks includes Multiple physical pixel elements respectively, the green element block includes two green physical pixel elements and two white physical pixel elements, the blue element block includes two blue physical pixel elements and two white physical pixel elements, and the red element block includes two red physical pixel elements and two white physical pixel elements;
calculating a green-white ratio of the green binning image data and the white binning image data of the green element block;
acquiring white residual data based on a difference between the white binning image data of the red element block or the blue element block, at a first pixel position where estimate green residual data should be estimated, and the white binning image data of the green element block, at the second pixel position adjacent to the first pixel position; and
estimating estimate green residual data corresponding to the first pixel position, based on the green-white ratio corresponding to the green element block at the second pixel position and the white residual data.

11. The method according to claim 10, further comprising:
acquiring, by the camera assembly, the white residual data, by subtracting the white binning image data of the green element block located at the second pixel position from the white binning image data of the red element block or the blue element block at the first pixel position.

12. The method according to claim 10, further comprising:
acquiring, by the camera assembly, the estimate green residual data, by multiplying the green-white ratio corresponding to the green element block located at the second pixel position with the white residual data.

13. The method according to claim 10, wherein the green element blocks, the blue element blocks, and the red element blocks have rectangular shape, and wherein
in the green element block, the two green physical pixel elements are located on a first diagonal line, and the two white physical pixel elements are located on a second diagonal line, corresponding to each of four corners, respectively,
in the blue element block, the two blue physical pixel elements are located on a first diagonal line, and the two white physical pixel elements are located on a second diagonal line, corresponding to each of four corners, respectively, and
in the red element block, the two red physical pixel elements are located on a first diagonal line, and the two white physical pixel elements are located on a second diagonal line, corresponding to each of four corners, respectively.

14. The method according to claim 10, further comprising:
generating, by the camera assembly, the green binning image data and the white binning image data of the green element block, the red binning image data and the white binning image data of the red element block, and the blue binning image data and white binning image data of the blue element block, by a binning process by using the image sensor.

15. The method according to claim 10, further comprising:
using, by the camera assembly, the green binning image data of the green element block, the red binning image data of the red element block, and the blue binning image data of the blue element block as the sparse image data conforming to the Bayer format.

16. The method according to claim 15, further comprising:
generating, by the camera assembly, the embedded sparse image data from the sparse image data, by embedding the estimate green residual data in the sparse image data at the first pixel position.

17. The method according to claim 7, further comprising:
processing, by an image signal processor, the sparse image data in the embedded sparse image data to generate a target image data; and
inputting, by the camera assembly, the embedded sparse image data to the image signal processor.

18. The method according to claim 17, further comprising:
obtaining, by the main processor, the embedded sparse image data from the image signal processor after the embedded sparse image data has been input to the image signal processor;
extracting, by the main processor, the estimate green residual data from the embedded sparse image data obtained from the image signal processor; and
reconstructing, by the main processor, the dense image data based on the estimate green residual data.

19. A non-transitory computer readable medium comprising program instructions stored thereon for performing at least the following:
acquiring green binning image data and white binning image data of green element blocks, red binning image data and white binning image data of red element blocks, and blue binning image data and white binning image data of blue element block, generated by the binning process of a camera assembly, wherein the camera assembly that includes an image sensor configured to capture an image of an object and to generate color image data, wherein the image sensor has the green element blocks, the blue element blocks, and the red element blocks arranged in an array of the Bayer format at each pixel position in order to generate color image data, the green element blocks, the blue element blocks, and the red element blocks includes Multiple physical pixel elements respectively, the green element block includes two green physical pixel elements and two white physical pixel elements, the blue element block includes two blue physical pixel elements and two white physical pixel elements, and the red element block includes two red physical pixel elements and two white physical pixel elements;
calculating a green-white ratio of the green binning image data and the white binning image data of the green element block;
acquiring white residual data based on a difference between the white binning image data of the red element block or the blue element block, at a first pixel position where estimate green residual data should be estimated, and the white binning image data of the green element block, at the second pixel position adjacent to the first pixel position; and
estimating estimate green residual data corresponding to the first pixel position, based on the green-white ratio corresponding to the green element block at the second pixel position and the white residual data.

20. The non-transitory computer readable medium according to claim 19, further comprising program for acquiring the white residual data, by subtracting the white binning image data of the green element block located at the second pixel position from the white binning image data of the red element block or the blue element block at the first pixel position.
